(19) United States
(12) Patent Application Publication
(10) Pub. No.: US 2010/0306706 A1
(43) Pub. Date: Dec. 2, 2010

(54) VISUAL-EDITING TOOLBAR MENU WHILE USING TEXT EDITOR

(75) Inventors: Bikram Singh Gill, Mohali (IN); Amar Kg, Bangalore (IN)

Correspondence Address: Trellis IP Law Group/Oracle, 1900 Embarcadero Road, Suite 109, Palo Alto, CA, 94303, US

(73) Assignee: Oracle International Corporation, Redwood Shores, CA (US)

(21) Appl. No.: 12/473,011

(22) Filed: May 27, 2009

(51) Int. Cl. G06F 3/048

(52) U.S. Cl. 715/839; 715/841; 715/810

(57) ABSTRACT

Particular embodiments provide a toolbar menu that includes one or more options that are valid for an object. A hot-key input is received that indicates a request for the toolbar menu. The request may be received while a user is using an application, such as a text editing application. The hot-key may be received from one or more keys on a keyboard and the request is associated with the object, which may be highlighted text. One or more options are determined that are valid for the object. For example, the application may be queried to determine which options are valid for the object. A toolbar menu is then displayed that includes the valid options. A selection from the user of one of the options causes an action for the option to be performed.

### BACKGROUND

Particular embodiments generally relate to visual editing options for an editor.

When typing in a text editor, a situation occurs where a user may want to edit a piece of text that was just typed or text that will be typed next. The edits may include changing a font or other options. Different options exist to allow a user to edit the text. One option is the user selects the text and has to remember a shortcut key for the edit option. Also, the user can right-click the highlighted text and then choose the edit option in an edit dialog box. A third option is the user can tab to the editor main menu found on the top of the interface and select the edit option from the main menu. However, in some cases, the icon for the desired edit option is not being displayed in the main menu. A last option is using the menu of the editor by selecting a menu item using a mouse pointer and using a pull-down menu. Each of these options are not very convenient because the user needs to remember a lot of short cuts or needs to go through a lot of steps to perform the editing option.

### SUMMARY

Particular embodiments provide a toolbar menu that includes one or more options that are valid for an object. A hot-key input is received that indicates a request for the toolbar menu. The request may be received while a user is using an application, such as a text editing application. The hot-key may be received from one or more keys on a keyboard and the request is associated with the object, which may be highlighted text. One or more options are determined that are valid for the object. For example, the application may be queried to determine which options are valid for the object. A toolbar menu is then displayed that includes the valid options. A selection from the user of one of the options causes an action for the option to be performed.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system for providing visual editing options according to one embodiment.

FIG. 2 depicts an interface of the application according to one embodiment.

FIG. 3 shows an example of a toolbar according to one embodiment.

FIG. 4 depicts a data flow for determining the valid options according to one embodiment.

FIG. 5 depicts a simplified flowchart of a method for providing the toolbar menu according to one embodiment.

### DETAILED DESCRIPTION OF EMBODIMENTS

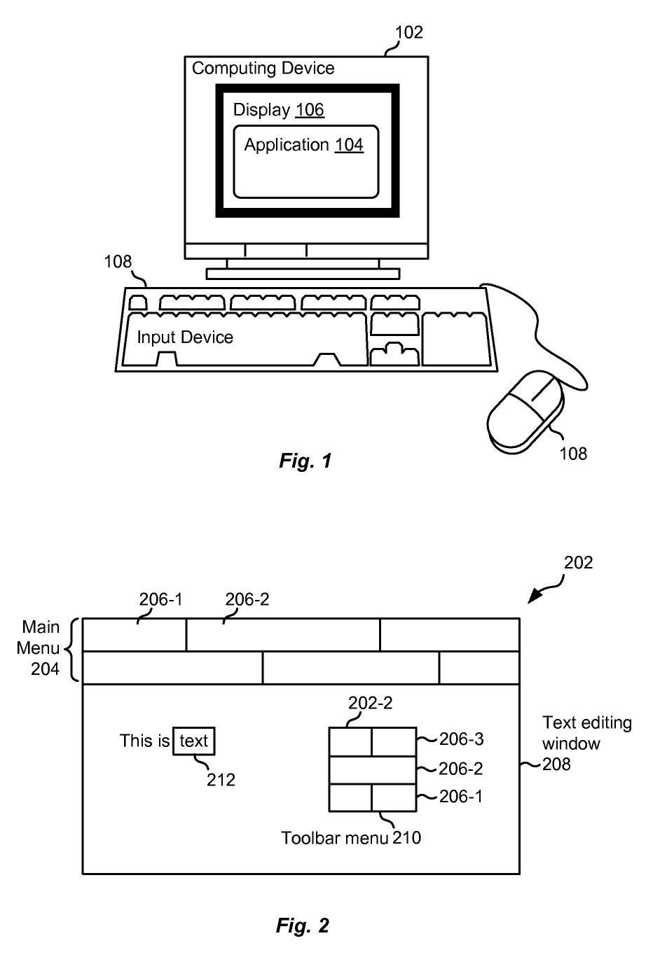

FIG. 1 depicts an example of a system 100 for providing visual editing options according to one embodiment. System 100 includes a computing device 102, display 106, and an input device 108. It will be understood that any number of the components shown in FIG. 1 may be provided. For example, a computing device 102 may be a distributed computing system where functions described may be distributed to different devices. Also, an application 104 may be found on computing device 102. In another embodiment, a client/server relationship is used where application 104 is on a server and accessed from a client.

Computing device 102 may be any computing device, such as a personal computing device, laptop, workstation, cellular phone, personal digital assistant (PDA), smartphone, netbook, or other computing devices capable of providing application 104. Computing device 102 also includes a display 106, which may be a liquid crystal display (LCD) screen, television, or other interface.

Input device 108 may be used by a user to provide input to application 104. In one example, input device 108 includes a keyboard of keys. Also, input device 108 may include a mouse, stylus for a touchscreen, or other input devices.

Application 104 may be an application that allows a user to input information, such as text, images, or other objects. Application 104 may be a text editor, such as a word processing application. Also, application 104 may be an application that includes a text editing aspect. The products in which editing may be performed include text editors, word processors, e-mail tools, CAD tools, web-pages/editors, and other text editors. For example, an instant messaging application may include a text editor to input text messages. Also, websites may include text editors. Further, a cellular phone may have a text editor for inputting text messages.

When a user is typing on input device 108, words may be displayed on display 106 as is known in the art. At some point, the user may need to edit an object. The object may be any information on display 106. For example, the object may be text, images, or other information (such as blank space—i.e., wherein the cursor is located or an area on the display). The options may be rich editor options which allow a user to perform advanced editing options. In one example, a user may want to change the font size of a previous word that was just typed. Advanced editing options may be manipulate formatted text, styled text or rich text (hereinafter formatted text), as opposed to plain text. The formatted text has styling information beyond the minimum of semantic information of plain text.

A hot-key may be used to indicate a request for a toolbar menu. A hot-key may be a single key, a key combination, or any number of keys that are depressed to indicate a request for the toolbar menu. A hot-key may be control-H, one of the function keys, or any other combination of keys. It should be noted that a function key may be a single keystroke that is pressed but may represent a key combination, such as the function key F1 when pressed may send the combination control-H to application 104.

In one embodiment, a hot-key is inputted from the keyboard. However, the hot-key may be inputted in other ways, such as through a selection using the mouse (right click, left click). Also, a verbal command may be used, such as a command that is recognized using voice recognition software. Thus, the hot-key may be a command that indicates a user's desire for the toolbar menu.

In one example, the user may highlight text shown in display 106. The text may be highlighted using a second hot-key. For example, the hot-key could be control+shift+left arrow key to select the text. Or, the hot-key requesting the toolbar may automatically highlight the last typed word. Also, a mouse may be used to select a word on the screen.

A toolbar menu is displayed when the hot-key is received. The toolbar menu displays one or more options that are valid for the object. In one embodiment, the toolbar menu is different from the main menu. For example, a main menu may be always shown (sometimes found on the top of the application). The main menu always displays icons for application 104. However, certain icons are valid depending on which object is highlighted. For example, when text is highlighted, different options are available from when a table is highlighted. The main menu may always appear but the toolbar menu may be dynamically generated and displayed when the hot key is received.

Both the main menu and the toolbar menu may be a layered toolbar. A layered toolbar may be separate toolbar categories that are displayed. Each layer may be a category of options. For example, application 104 may categorize options for the toolbar. One category may be options related to font, such as bold, italics, and underline, and another layer is related to options for a table. Generally, options that are related are in a layer. The categories may be classified in code for the application, such as in a registry.

The layers, in which icons are displayed, are used for logically grouping of related icons, e.g., the top one or two layers display simple font related direct editing of text (change size, font, superscript, subscript, underline, etc.) and the second set of layers may be used for options that modify the text by adding hidden information on the highlighted text/current location (e.g., adding a bookmark, inserting a link, note, etc). Similarly other layers may be for displaying advanced editing options, document review icons, inserting special text (emoticons, numbering, etc). A layer may be defined as a way of organizing the display icons in logical groups, so a user can easily find the relevant icons/edit-options. Different applications can choose different logical groupings that are relevant to the application context, e.g., a chat client may want to display text edit options in one layer, emoticon/quote insert options in another layer, sending a file/cobrowsing/etc. icons in a 3^{rd} layer. In addition, layering may be done based on a user preference of maximum icons to show in a single layer, and the rest may be folded to the next layer. The application may store the settings that define the logical groupings. These groupings are used to display the layers in the toolbar menu.

When the toolbar menu is displayed in response to receiving the hot key, the user may then navigate the toolbar menu to choose an object. For example, focus may be automatically provided for the toolbar menu to allow a user to use right/left arrow keys to choose one of the options. Also, up/down arrow keys may be used to change layers.

Once the option is selected, application 104 performs the action associated with the option. For example, an icon for italics may cause the selected text to be changed to italics.

FIG. 2 depicts an interface 202 of application 104 according to one embodiment. Interface 202 includes a main menu 204. Main menu 204 may be a fixed toolbar that is displayed for interface 202. Main menu 204 may always be displayed once configured. However, a user may have a choice of which toolbar layers should be displayed in main menu 204. For example, a selection process allows the user to select different layers. The layers may be divided in sections 206 (shown as 206-1 and 206-2) in main menu 204. A user may configure main menu 204 by selecting what layers should be displayed in main menu 204.

Toolbar menu 210 may be organized similar to menus found in main menu 204. For example, the different layers that are found in main menu 204 may be provided in toolbar menu 210. This is different from a reconfigured menu that may be displayed when a right click is provided. When a right click is provided, a list of menus is displayed. This list of menus is preconfigured. That is, when the right click for an object is performed, the same options for the right click are provided as is programmed in application 104 (i.e., the options to display the menu is hard coded). The same options are displayed. Thus, options that may not be relevant are still displayed. This is because the menu is preconfigured. However, particular embodiments query for the valid options in real time and receive the options from application 104. An object is processed to determine which are the valid options at that moment in which the hot-key input is received. This allows particular embodiments to provide a toolbar menu that includes valid options and not display options that are not available.

A layer is defined by application 104 as a related group of options. The grouping may be stored in application 104. For example, a registry may indicate which options should be categorized together. A category may be assigned to different toolbar layers. For example, a formatting toolbar includes formatting options. Also, a drawing toolbar includes drawing options. In configuring application 104, a user can select which category and have these options displayed in main menu 204. Particular embodiments use those options to generate toolbar menu 210. These categories may be defined in application 104, such as in the registry for application 104 or in the software code for application 104.

A text editing window 208 is also provided. This allows a user to type in information. For example, a user may be typing words or characters into a document. When a word is selected, a hot-key may be input by a user. A toolbar menu 210 may then be dynamically generated and displayed automatically in response to receiving the hot-key. As shown, different layers 206 are provided in the toolbar. A user may navigate within the different layers.

Toolbar 210 may be instantaneously displayed in response to receiving the hot-key. For example, once the hot-key is processed by application 104, toolbar 210 may be displayed. The position in which toolbar 210 is displayed may be relative to object 212. For example, toolbar 210 may appear to be floating in interface 208 and may be displayed in different positions based on the position of object 212, such as in a position near object 212, the toolbar is displayed. It should be noted that toolbar 210 is different from main menu 204 in that main menu 204 is always displayed in interface 202 while toolbar 210 is displayed when the hot-key is received.

As mentioned above, toolbar 210 displays options that are valid for object 212. Thus, if an option is not available for object 212, then it may not be displayed. In other embodiments, if the option is not valid, it may be displayed but is not available for input by the user. For example, the option may be grayed out and a user cannot select this option or, if it is selected, the action does not occur.

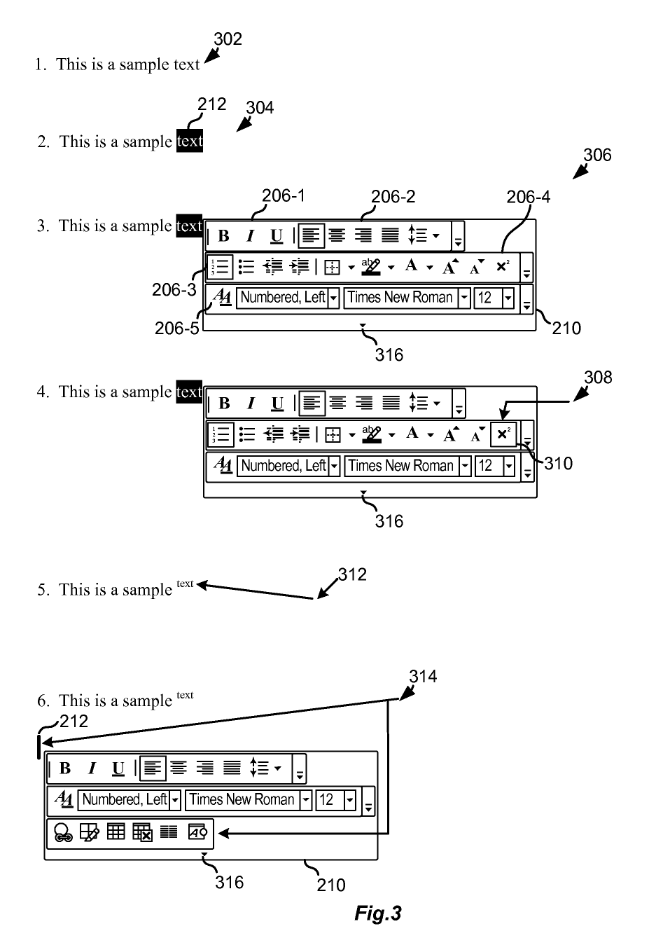

FIG. 3 shows an example of toolbar 210 according to one embodiment. At 302, the user types the text “This is a sample text.” Nothing has been selected yet. At 304, a user selects the word “text”. For example, the user may use the key combination control+shift+left arrow key to select the word “text”.

At 306, a hot-key input is received from the user. Toolbar menu 210 is then displayed. Focus is provided on toolbar menu 210 to allow the user to use navigation keys, such as arrow keys, to navigate through the options. Also, the user may use other input devices, such as a mouse, to navigate through the options.

As shown, different layers 206 are provided. These layers may be shown next to each other as in layers 206-1 and 206-2 and layers 206-3 and 206-4. Also, layers may be vertically situated, such as layer 206-5 is below layers 206-3 and 206-4. Users may navigate through the icons in each layer. As shown in 308, a user has traversed to a superscript icon 310. The user may press enter and the enter command is received. This causes the superscript command to be executed by application 104. In 312, the word “text” has been edited to be a superscript.

At 314, an example toolbar 210 is shown when a selection of another object 212 is received from a user. In this case, the user may have pressed enter twice and selected the hot-key. The hot-key command is received and the object 212 is the cursor (e.g., no selected text). A modified toolbar 210 is provided that includes valid options for objects 212. In this case, the options allow the user to change the format of text inserted from that cursor location or options to insert a table, make an Excel table, or page column. Thus, different options have been provided for the different objects. The options are determined automatically when the hot-key is received.

Moreover the layering may allow display of more frequently used options in a default display, which is shown when the hot-key is first pressed. While more advanced and seldom used editing options could be shown in extra layers than shown initially, which are displayed when the user presses an icon 316 on the displayed toolbar 210 (in one embodiment, this is the bottom arrow icon 316; however, it could be another hotkey combination or icon also). The information whether an option is to be shown in default display, or in extended/advanced display can be retrieved from the application, along with the options themselves, when the user presses the hotkey.

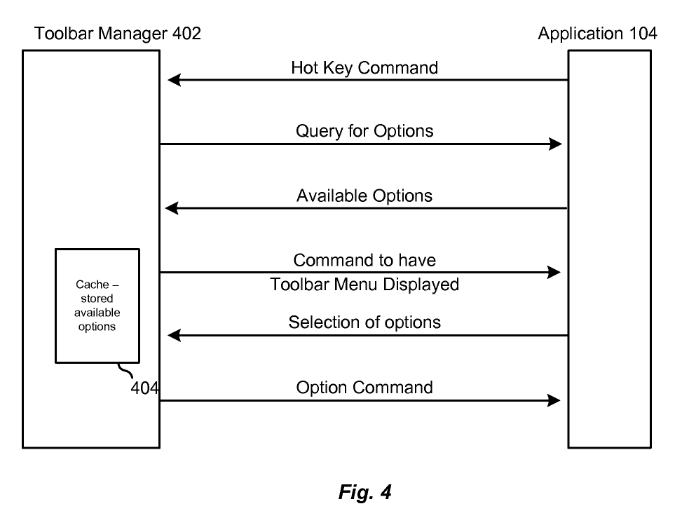

One embodiment for determining valid options will now be discussed. FIG. 4 depicts a data flow for determining the valid options according to one embodiment. FIG. 4 shows a toolbar manager 402 and application 104. It will be understood that manager 402 may be included in application 104. For example, manager 402 may be included in or separate from application 104. For example, it may be a module that is messaging with application 104. If toolbar manager 402 is included with application 104, the messaging may occur internally.

When application 104 receives a hot-key command from a user, it sends it to toolbar manager 402. Toolbar manager 402 then queries application 104 for valid options. For example, different applications may store which options are available for different objects. A text editing application may include extensions in a registry that may be queried for through an application programming interface. In this case, the query may be sent to application 104 and request for options that are available for the object.

Application 104 may then send the available options to toolbar manager 402. The available options may be stored in storage 404, such as cache. This allows toolbar manager 402 to bypass querying for the available options if the hot-key command is received for the same object. For example, the available options may just be retrieved from cache in this case.

Toolbar manager 402 then generates a command to have toolbar 210 displayed. For example, a command that tells application 104 to generate a toolbar is sent to application 104. This may indicate which options should be displayed in toolbar menu 210. This command is sent to application 104. Application 104 then is configured to display toolbar menu 210. Toolbar menu 210 may include visual representations of the options, such as icons. The visual representations are determined for the options and displayed. The user may then navigate toolbar menu 210 and select an option. The option is then received at application 104.

Application 104 sends the selection to toolbar manager 402. Toolbar manager 402 then analyzes the selection and determines which option has been selected. For example, if the italics icon has been selected, then a command is generated to have the italics option executed by application 104. The command indicates that application 104 should apply the italics option to the selected object. This command is sent from toolbar manager 402 to application 104.

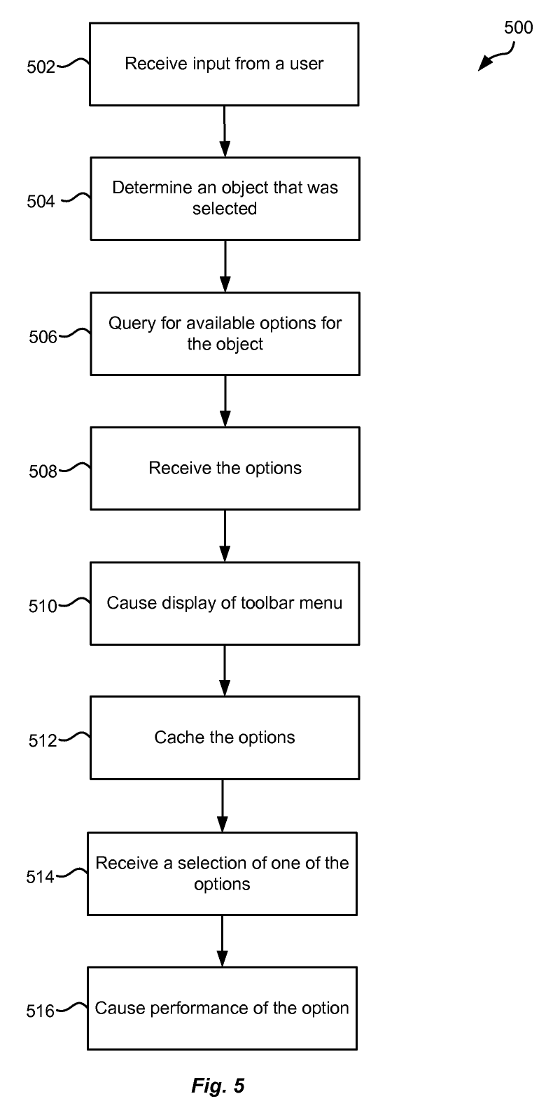

A method of an overview of the process for using toolbar menu 210 will now be described. FIG. 5 depicts a simplified flowchart 500 of a method for providing toolbar menu 210 according to one embodiment. Step 502 receives input from a user. The input may be a hot-key selection.

Step 504 determines an object 212 that was selected. For example, some text may have been selected in interface 202.

Step 506 queries for available options for the object. The query may depend on the application 104 being used. For example, different queries may be formulated for different applications.

Step 508 receives the options. Step 510 then causes display of toolbar menu 210. For example, a command to display toolbar menu 210 may be generated and sent to application 104.

Step 512 caches the options. The caching of the options allows the display of toolbar menu 210 without querying application 104 when the hot-key selection is received for a same object.

Step 514 receives a selection of one of the options. For example, a user may select an icon.

Step 516 then causes performance of the option. For example, a command to cause the option to be performed is sent to application 104.

Particular embodiments provide many advantages. For example, the use of the hot-key allows a user to display the toolbar menu using keyboard 108. A right click on a mouse is not needed in this case. Also, the hot-key automatically provides focus on toolbar menu 210. Thus, a user can use navigation keys on keyboard 108 to navigate to an option that is desired. A user can use options, such as rich editing options of an application while the user is typing by selecting a few keystrokes. A lot of hot-key options are not needed. Because the controls are more user-friendly and easily accessible to a user, the options may be used more frequently. For example, remembering a hot-key for each of the options in toolbar menu 210 may be hard for a user. However, if a user can remember one hot-key and be provided with valid options for different objects that are selected, the user may be more likely to use toolbar menu 210. Further, by providing multiple layers in toolbar menu 210, a user can access multiple different options in a friendlier user display, as layering can be used to avoid cluttering of all available options in a single layer/box.

Further, by querying application 104, the valid options for the object can be determined. This provides a toolbar menu that may be configured dynamically with only valid options. Also, the valid options may be cached such that the querying does not need to be performed when another request for toolbar menu 210 is performed. The cache may be cleared when the application is shut down or exited. The querying may be performed again upon instantiation of the application. This may allow upgrades to the application where different options may be added. The toolbar menu is not set for specific objects, so the querying may pull the valid options. Thus, the toolbar menu may be different based on which options are valid. Also, a user may set preferences. For example, a user's preferences may be used to indicate which options should be valid for an object. When the query is performed, the valid options based on the user's preferences are determined. User preference may also be used to capture the most frequently used options, which will then be displayed in the default mode of the toolbar display on pressing the hotkey; the rest of the options could be displayed in the extended/advanced mode of the toolbar when the user presses the extended view icon on the toolbar (e.g. the bottom arrow icon under 206-5)

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
receiving a hot key input indicating a request for a toolbar menu for an application being used, the hot key being received from one or more keys on a keyboard, wherein the request is associated with an object;
determining one or more options that are valid for the object, wherein the application is queried to determine the one or more options that are valid; and
displaying the toolbar menu on a computing device, the toolbar menu including the one or more options that are valid for the object, wherein the one or more options allow editing of the object.

2. The method of claim 1, further comprising:
querying the application with a request for valid options for the object; and
receiving the one or more options that are valid.

3. The method of claim 2, further comprising:
determining visual representations for the one or more options; and
displaying the visual representations for the one or more options in the toolbar.

4. The method of claim 2, further comprising storing the one or more options that are valid for the object, wherein the stored one or more options are determined when a second request for a toolbar menu associated with the object is received.

5. The method of claim 4, wherein the application is not queried to determine the one or more options when the second request is received.

6. The method of claim 1, wherein the one or more options are displayed in a layered toolbar.

7. The method of claim 6, wherein a layer in the layered toolbar comprises a category of options.

8. The method of claim 7, wherein the category of options is defined by the application.

9. The method of claim 6, further comprising:
receiving an input from the user to navigate from one layer to another layer; and
causing focus to move from the one layer to another layer.

10. A computer-readable storage medium comprising encoded logic for execution by the one or more processors, the logic when executed is operable to:
receive a hot key input indicating a request for a toolbar menu for an application being used, the hot key being received from one or more keys on a keyboard, wherein the request is associated with an object;
determine one or more options that are valid for the object, wherein the application is queried to determine the one or more options that are valid; and
display the toolbar menu on a computing device, the toolbar menu including the one or more options that are valid for the object, wherein the one or more options allow editing of the object.

11. The computer-readable storage medium of claim 10, wherein the logic is further operable to:
query the application with a request for valid options for the object; and
receive the one or more options that are valid.

12. The computer-readable storage medium of claim 11, wherein the logic is further operable to:
determine visual representations for the one or more options; and
display the visual representations for the one or more options in the toolbar.

13. The computer-readable storage medium of claim 11, wherein the logic is further operable to store the one or more options that are valid for the object, wherein the stored one or more options are determined when a second request for a toolbar menu associated with the object is received.

14. The computer-readable storage medium of claim 13, wherein the application is not queried to determine the one or more options when the second request is received.

15. The computer-readable storage medium of claim 10, wherein the one or more options are displayed in a layered toolbar.

16. The computer-readable storage medium of claim 15, wherein a layer in the layered toolbar comprises a category of options.

17. The computer-readable storage medium of claim 16, wherein the category of options is defined by the application.

18. The computer-readable storage medium of claim 15, wherein the logic is further operable to:
receive an input from the user to navigate from one layer to another layer; and
cause focus to move from the one layer to another layer.

19. An apparatus comprising:
one or more processors; and
logic encoded in one or more computer readable storage media for execution by the one or more processors and when executed operable to:
receive a hot key input indicating a request for a toolbar menu for an application being used, the hot key being received from one or more keys on a keyboard, wherein the request is associated with an object;
determine one or more options that are valid for the object, wherein the application is queried to determine the one or more options that are valid; and
display the toolbar menu on a computing device, the toolbar menu including the one or more options that are valid for the object, wherein the one or more options allow editing of the object.

20. The apparatus of claim 19, wherein the logic is further operable to:
query the application with a request for valid options for the object; and
receive the one or more options that are valid.
